(19) United States
(12) Patent Application Publication
(10) Pub. No.: US 2015/0376803 A1
(43) Pub. Date: Dec. 31, 2015

(54) Gas Diffusion Electrodes and Methods for Fabricating and Testing Same

(71) Applicant: BROOKHAVEN SCIENCE ASSOCIATES, LLC, Upton, NY (US)

(72) Inventor: Jia Xu Wang, East Setauket, NY (US)

(73) Assignee: Brookhaven Science Associates, LLC, Upton, NY (US)

(21) Appl. No.: 14/431,338

(22) PCT Filed: Oct. 9, 2013
(86) PCT No.: PCT/US2013/064073

§ 371 Date: Mar. 26, 2015

Related U.S. Application Data
(60) Provisional application No. 61/711,570, filed on Oct. 9, 2012.

(51) Int. Cl. C25B 11/04; H01M 4/88; H01M 4/86; H01M 4/90; H01M 4/92

(52) U.S. Cl. CPC C25B 11/0405; H01M 4/9016; H01M 4/9083; H01M 4/921; C25B 11/0415; C25B 11/0473; H01M 4/8605; H01M 4/9041; H01M 4/8839

(57) ABSTRACT

Highly effective, standalone gas-diffusion electrodes (GDEs) and the methods for their manufacture and test are disclosed, Nanocataiysis are directly bonded on a gas diffusion layer, so that the integrity of the catalyst layer holds without polymer electrolyte membrane, facilitating minimization of electronic, prottmtc, and diffusion resistances in the catalyst layer. The devised embodiments provide examples showing a facile hanging-strip method for testing the standalone GDEs in a solution electrochemical cell, which removes the mA-cm⁻²-scale mass transport limited currents on rotating disk electrodes to allow studies of reaction kinetics on single electrode over sufficiently wide current ranges (up to A cm⁻²) without mass transport limitation. Ultralow-Pi-content GDEs are fabricated as the cathode for hydrogen evolution in water eiectrolyzers and as the anode for hydrogen oxidation in hydrogen fuel cells. High performance GDEs with low loadings of platinum group metals are being developed for oxygen evolution reaction at the anode of water electrolyzers and for the oxygen reduction reaction at the cathode of fuel cells.

### CROSS-REFERENCE TO A RELATED APPLICATION

This application claims the benefit under 35 U.S.C. 119(e) of U.S. Provisional Application No. 61/711,570 filed on Oct. 9, 2012, the content of which is incorporated herein in its entirety.

### STATEMENT OF GOVERNMENT LICENSE RIGHTS

The present invention was made with Government support under contract number DE-AC02-98CH10886 awarded by the U.S. Department of Energy. The Government has certain rights in the invention.

### FIELD OF THE INVENTION

The invention relates to polymer electrolyte membrane fuel cells and water electrolyzers. In particular, the invention relates to standalone gas diffusion electrodes based on dispersed catalytic nanoparticles in a conductive network with tunable porosity and hydrophobicity. The invention also relates to a method of manufacturing such electrodes and a method of using the synthesized electrodes in polymer electrolyte membrane fuel cells and water electrolyzers. Finally, the invention also relates to methods for testing gas diffusion electrodes in a solution electrochemical cell.

### BACKGROUND

Water electrolysis using polymer electrolyte membrane (also known as proton exchange membrane or PEM) can produce pure pressurized hydrogen gas (200-2400 psi) from deionized water. To make the technology economically viable, significant research was undertaken aimed at improving the efficiency and reducing the cost of the PEM devices. It is well understood that the performance of polymer electrolyte membranes depends on the properties of metal nanoparticles used as catalysts. However, it also depends on how the metal nanoparticles are assembled in the device.

A typical membrane electrode assembly (MEA) has five distinct layers: (1) a polymer electrolyte membrane, (2) an anode catalyst layer, (3) a cathode catalyst layer, (4) an anode associated gas diffusion layer, and (5) an cathode associated gas diffusion layer. In the membrane electrode assembly illustrated in FIG. 1, the polymer electrolyte membrane (PEM) is sandwiched between the anode and the cathode catalyst layers, which are provided with their associated gas diffusion layers (GDL) to afford electrical connection and a path for inlet gaseous reactants in fuel cells or outlet products in hydrogen generators. To make highly efficient membrane electrode assemblies with low catalyst loadings, the nanocatalysts need to be well-connected electronically to the gas diffusion layers and well-connected protonically to the polymer electrolyte membrane. Additionally, the catalyst layer (CL) must be sufficiently porous to allow sufficient penetration by the gaseous reactants/products. The standard approach of making membrane electrode assemblies (known as the catalyst coated membrane method) is based on forming the catalyst layers on membranes before adding respective gas diffusion layers (see e.g. U.S. Pat. No. 5,211,984; incorporated by reference in its entirety).

FIG. 2 illustrates a typical catalyst coated membrane and gas diffusion layer presented with/without an optional microporous layer (MPL), which reduces surface roughness and allows for fine tuning of the porosity and hydrophobicity of the gas diffusion electrode. In such systems, however, the catalyst layer is densely packed having pores that are significantly smaller than the pores in the gas diffusion layer. Since most of the particles are not directly in contact with the gas diffusion layer, catalysts must packed densely to insure a continuous path for electrons to travel based on particle contacts. However, the need for particle contacts in electron conductivity competes with proton and gas diffusion paths, and as such makes it difficult to reduce the total resistance in a typical membrane electrode assembly described above. There is, therefore, a need for an improved membrane electrode assembly with a reduced total resistance and a method of fabrication thereof.

The difficulty in developing membrane electrode assemblies with reduced total resistance, including electron transport, proton transport and gas transport, also stems from the lack of feasible test methods that are sensitive enough to distinguish between different nanocatalysts. Typically, the membrane electrode assemblies manufactured based on the catalyst coated membrane method set the performance baseline for testing new catalysts and fabrication methods (Debe, M. K. et al., J. Electrochem. Soc. 159, K165, 2012, incorporated by reference in its entirety). The new catalysts and fabrication methods are screened and optimized within the whole membrane electrode assembly. However, such tests can be very costly and time consuming. In addition, testing of one electrode (anode or cathode) requires a pairing with the opposite charge electrode, which complicates data analysis and increases uncertainty due to the variations at the pairing electrode.

Although, a single electrode reaction can be studied with a well-defined reference electrode with the catalysts attached to a rotating disk electrode (RDE), the mass transport rates on the RDE are more than a hundred-fold lower than that used in MEA tests, which limits the reaction currents. Therefore, the sensitivity of the RDE-based tests is quite low for the intrinsic catalytic activity, e.g. the hydrogen evolution reaction (HER) and/or the hydrogen oxidation reaction (HOR). Moreover, the potential window in RDE-based tests is only about 0.2 V, making it difficult to study its catalytic behavior at large overpotentials and high current densities of the oxidation reduction reaction (ORR).

There is, therefore, a need for an improved method to study and evaluate catalytic behavior on a single electrode without mass-transport limitations that would permit a fabrication of highly effective gas diffusion electrodes having reduced precious metal loading.

### SUMMARY OF THE INVENTION

In view of the above-described problems, needs, and goals, novel gas diffusion electrodes and a method of their manufacture and use are provided. Preferably, the disclosed gas diffusion electrodes are used in a membrane electrode assembly for proton exchange membrane fuel cells or proton exchange membrane electrolyzers. The disclosed gas diffusion electrodes allow the simultaneous minimization of electronic, protonic, and gas diffusion resistances, and thus, enhance the performance and lower the cost of fabrication and operation of fuel cell and/or electrolyzer systems.

The disclosed gas diffusion electrodes have a conducting network, preferably made from carbon or titanium, which functions as a gas diffusion layer supporting an ultra-thin (i.e., micrometer scale and preferably between 0.5 μm to 4 μm) catalyst layer. The catalytic layer is coated on one side of a gas diffusion layer in such fashion that would allow for high dispersion of nanocatalyst in the 3D reaction volume of the conducting network. For example, FIG. 3 illustrates a catalyst layer partly embedded into the carbon fiber network, which is fabricated using acid-treated carbon nanotubes to build a micrometer-thick subnet as the microporous layer.

It is believed that the high dispersion of the nanocatalysts contributes to the enhancement of the electrode's reaction rate. The contact resistance of the catalyst layer can be minimized by having all the particles on or close to highly conductive gas diffusion layer. The performance of the catalyst layer can be further optimized by tuning its porosity through the three-dimensional space of the gas diffusion layer, which minimizes the contact resistance and maximizes accessibility to the catalyst. The dispersed nanocatalysts preferably form a continuous path with the conducting network to permit a long range electron transfer though the 3D space. For the convenience of the reader, the disclosed gas diffusion electrode having catalyst(s) dispersed in a 3D space will be referred to as the 3D-net gas diffusion electrode (GDE) throughout this application.

The conducting network may optionally have a microporous layer (MPL) on one side of the conducting network to reduce surface roughness and allows for fine tuning of the porosity and hydrophobicity of the gas diffusion electrode. Depending on the catalyst formulations, the catalytic nanoparticles can be attached on the gas diffusion layer to ensure its integrity and allow the gas diffusion electrodes to function without a membrane.

The catalyst used in the disclosed 3D-net GDEs is not limited to a particular form, as long as it is a solid, hollow or core/shell nanoparticle (shell portion) made at least partially from metal, metal oxide, or metal alloy, where the metal is selected from platinum (Pt), palladium (Pd), gold (Au), rhodium (Rh), iridium (Ir), ruthenium (Ru), silver (Ag), or rhenium (Re). If the nanoparticle is a core/shell nanoparticle, the core can be selected from a suitable metal, metal oxide or metal alloy, such as, but not limited to, palladium (Pd), gold (Au), rhodium (Rh), iridium (Ir), ruthenium (Ru), osmium (Os), rhenium (Re), nickel (Ni), cobalt (Co), iron (Fe), copper (Cu), and combinations thereof. The core can be crystalline, semi crystalline or amorphous. It is to be understood, however, that the invention is not limited to a metal core and may include other materials which are well-known in the art including semiconductors.

The selection of the metal to be used in the catalysis depends on the desired reaction. For example, if the desired reaction is the hydrogen evolution and/or oxidation, the catalyst preferably comprises platinum (Pt) or platinum alloy. In one exemplary embodiment, the catalyst is Ru/Pt core/shell nanoparticles having the negligible charge transfer resistance for hydrogen evolution and oxidation reactions. In such embodiment, Pt loading can be less than 30 μg cm⁻².

The manufacturing process for the disclosed gas diffusion electrode is simple and cost-effective. The manufacturing process provides electrodes with higher tunable catalytic activities, improved durability, and reduced resistance in combination with minimal loading of precious materials compared to electrodes currently in use. In one embodiment, the disclosed gas diffusion electrode is prepared by a method that has the following essential steps: (i) uniformly disperse a nanocatalyst in a solvent containing a binder to form a catalyst ink; (ii) uniformly paint a desired area of gas diffusion layer (GDL) with the catalyst ink; (iii) allow the ink to dry; and (iv) repeat catalyst painting to achieve desired catalyst loading.

The manufactured electrode can be used in fuel cells and electrolyzes. The manufacturing process for the disclosed gas diffusion electrode can also have an additional step of incorporating a microporous layer (MPL) to reduce surface roughness and allows for fine tuning of the porosity and hydrophobicity of the gas diffusion electrode.

A novel (“hanging-strip”) method for evaluating catalytic behavior of gas diffusion electrodes on a single electrode without mass-transport limitations is also within the purview of this invention. The testing results can provide guidance for performance optimization and minimization of the precious metal loading. In one embodiment, the method has the following essential steps:

(i) coating one end of a gas diffusion layer with a catalyst layer;

(ii) holding the coated gas diffusion electrode vertically with the catalyst layer immersed in electrolyte solution facing a counter electrode;

(iii) having a reference electrode in the electrochemical cell; and

(iv) measuring electrocatalytic currents and impedance spectra at potentials against the reference electrode.

The electrocatalytic currents for single-electrode reactions are believed to be highly-enhanced in the “handing-strip” method compared to commonly-used rotating disk electrode method. In particular, the mass transport limits on electrical currents for hydrogen oxidation reaction (HOR) and oxygen reduction reaction (ORR) can be removed on well-fabricated gas diffusion electrodes when measured using the disclosed “hanging-strip” method. Preferably, the method is used in reactions where the reactant/product gas comprises hydrogen or oxygen. Using the disclosed method for evaluating catalytic behavior of gas diffusion electrodes, in one exemplary embodiment, the linear, symmetric polarization behavior of the hydrogen oxidation reaction and hydrogen evolution reaction (HER) on Ru(core)-Pt(shell) nanoparticles (denoted as Ru@Pt) contributes to a profound effect of gas transport even when gas is not a reactant, but a product. In another exemplary embodiment, a decrease of three orders-of-magnitude in charge transfer resistance (CTR) compared with that on Ru nanoparticles can be achieved to below 0.1 Ωcm² with only 10 μg cm⁻² Pt loadings in 1 M HClO₄ at 23° C. In yet another exemplary embodiment, the optimal shell thickness is a bilayer for Ru@Pt nanocatalysts in Pt-loading dependent charge transfer resistance. In still another exemplary embodiment, high-performance gas diffusion electrodes for hydrogen evolution reaction in proton exchange membrane electrolyzers can lead to a >98% reduction of the Pt content in comparison with the baseline loading. The disclosed method for evaluating catalytic behavior of gas diffusion electrodes can be also successfully used to design carbon monoxide-tolerance HOR gas diffusion electrodes with ultra-low precious metal loadings. The disclosed method can be used to design electrodes with enhanced performance for the oxygen reduction reaction using functionalized carbon nanotubes (CNTs) in microporous layers and catalyst layers. Finally, the disclosed method can be used to design gas diffusion electrodes with the enhanced oxygen evolution reaction performance using RuIr nanocatalysts on Ti-based gas diffusion layers.

These and other characteristics of the gas diffusion electrodes, a method of synthesis, manufacture and use thereof, and a method for evaluating catalytic behavior of gas diffusion electrodes will become more apparent from the following description and illustrative embodiments which are described in detail with reference to the accompanying drawings. Similar elements in each figure are designated by like reference numbers and, hence, subsequent detailed descriptions thereof may be omitted for brevity.

### BRIEF DESCRIPTION OF THE DRAWINGS

FIG. 1 is a schematic illustration of a typical membrane electrode assembly (MEA) of the PEM device having five distinct layers: (1) a polymer electrolyte membrane, (2) an anode catalyst layer, (3) a cathode catalyst layer, (4) the anode associated gas diffusion layer, and (5) the cathode associated gas diffusion layer.

FIG. 2 is SEM image(s) of typical catalyst coated membrane and gas diffusion layers. Left image is a slice through of a carbon fiber based gas diffusion layer at 100 μm scale. Center image is a slice though of a catalyst coated membrane at 5 μm scale. Right image is a slice through of a gas diffusion layer with a microporous layer (MPL) at 50 μm scale.

FIG. 3 illustrates top-view scanning electron microscopic image of a gas diffusion electrode having a catalyst layer partly embedded into the carbon fiber network fabricated using acid-treated carbon nanotubes.

FIG. 4 is a schematic of an exemplary electrochemical cell used in the disclosed hanging strip method.

FIG. 5A is a plot showing open circuit potentials on a GDE (solid line) and a RDE rotating at 2500 rpm (dashed line) measured as a function of time after the gas inlet above the 1 M HClO₄ solution was switched from Ar to H₂. The insert illustrates the gas transport path through the microporous channels in a GDE to the Pt catalyst in contrast to first dissolving and then diffusing through the electrolyte solution to reach the Pt catalysts on the RDE.

FIG. 5B is plot showing typical polarization curves on GDEs (solid lines) compared with that on the RDEs (dotted lines) for the HER, HOR, and ORR on 0.2 cm⁻² electrodes.

FIG. 5C is a plot showing iR-free polarization curves plotted in voltage as a function of current for the data illustrated in FIG. 5B.

FIG. 5D is a plot showing iR-free polarization curves for the HER-HOR on a GDE and a RDE (2500 rpm) with the same amount of Ru@Pt/C catalysts (20 μg cm⁻² Pt, 11 μg cm⁻² Ru).

FIG. 6A is a plot showing iR-free polarization curves for the HER-HOR measured on 1 cm² GDEs with Ru (dotted line) and Ru@Pt nanocatalysts (dashed and solid lines).

FIG. 6B is an electrochemical impedance spectrum measured on the GDEs in corresponding to the polarization curves shown in FIG. 6A. The curve with open circles is plotted using left-bottom axes and the curves with solid squares and triangles are plotted using the top-right axes.

FIG. 7 is a plot showing charge transfer resistance (CTR) as a function of Pt loading on 1 cm² GDEs (1.4 cm wide and 0.7 cm high catalyzed area) for the Ru@Pt catalysts with different Pt:Ru atomic ratios, which resulted in different Pt shell thicknesses.

FIGS. 8A-8D are plots showing the apparent activation barrier determined by measured temperature dependence for HER-HOR on a GDE catalyzed by Ru@Pt. (4A) Polarization curves, (4B) impedance spectra, (4C) iR-free polarization curves with the CTR values obtained by PR-HFR. (4D) Arrhenius plot yielding an apparent activation barrier of 0.2 eV or 19 kJ/mol.

FIG. 9 is a plot showing a comparison of water-electrolysis polarization curves of two samples prepared via GDE approach using Ru@Pt as the cathode catalysts with a baseline (Pt black as the catalyst) representing current performance of commercial PEM water electrolyzers.

FIG. 10 is a cross-sectional scanning electron microscopic image of a high performance GDE fabricated using a GDL that has a MPL (Avcarb GDS 120) and Ru@Pt nanocatalysts.

FIG. 11 is a plot showing cathode durability over 1500 hours for two ultralow-Pt-content GDEs. Inset shows the three-cell stack, in which the voltage over each of the two testing and one baseline cells were monitored over time.

FIG. 12 is a plot showing anode cycling stability of an ultralow-Pt-content GDE having Ru@Pt catalysts as the anode for the HOR in PEM fuel cells. Virtually no change in polarization curves measured after 2500 anode potential cycles between 0.02 and 0.95 V for ˜65 hrs has been observed.

FIG. 13A shows plots of HOR currents on GDE strips at 50 mV overpotential as a function of time before, during, and after exposure to 270 ppm CO-containing hydrogen. The currents are normalized to the initial values in pure hydrogen. The Pt shell thickness is about 1 and 2 monolayer for Pt:Ru atomic ratio of 0.5 and 1.0, respectively. The less Pt loading for the monolayer-thick Ru@Pt_{0.5} is to make Pt surface area comparable for other two ˜bilayer-thick Ru@Pt samples.

FIG. 13B is a plot showing iR-free HER-HOR polarization curves after the measurements shown in FIG. 13A.

FIG. 14 is a plot showing the ORR polarization curve on a GDE compared to the ORR polarization curve on a RDE. The plot demonstrates the absence of mass transport limit at 800 mA cm⁻², that is >100 times higher than the 6 mA cm⁻² limiting current on RDEs.

FIG. 15A is a plot showing ORR polarization curves measured for two GDE samples with the MPL fabricated with functionalized CNT (Labeled as A and B) compared to one with regular MPL composed of carbon particles (labeled as C). Sample A differs from B by further having functionalized CNT in the catalysts layer (CL). Dashed lines are measured currents and solid lines are iR-free polarization curves.

FIG. 15B shows the HFR-shifted impedance spectra measured at 0.8 V for the three GDE samples of FIG. 15A.

FIG. 15C is a plot showing Pt mass-normalized polarization curves for the three GDE samples of FIG. 15A, which shows that adding CNT to strengthen the conductive network enhances ORR activity.

FIG. 16A is a plot showing OER polarization curves and impedance spectra (inset) measured on GDEs made of RuIr and commercial Ir catalysts.

FIG. 16B is a semi-log plot of iR-free voltages versus mass-normalized current using the data in FIG. 15A.

FIG. 17 is a plot showing the current stability for the OER measured after step increase of potential for the RuIr catalysts on a GDE strip in an acid solution.

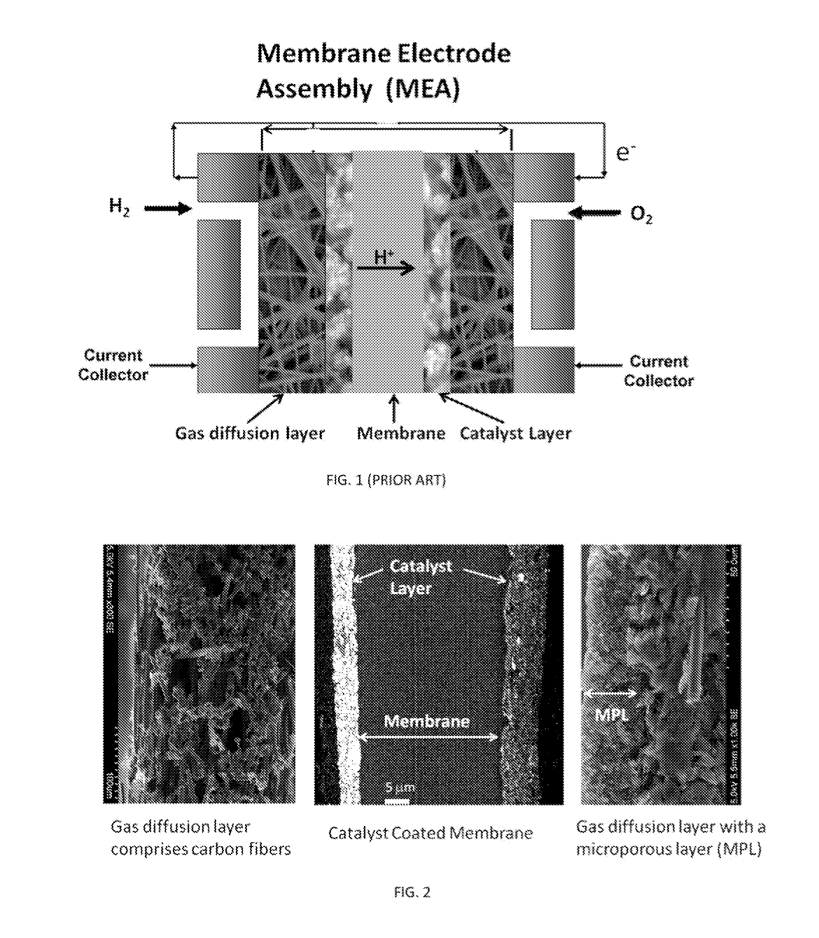

### DETAILED DESCRIPTION OF THE INVENTION

In the interest of clarity, in describing the present invention, the following terms and acronyms are defined as provided below:

Acronyms:
CCM; Catalyst coated membrane
CL: Catalyst Layer
CTR: Charge transfer resistance
f-CNT: Functionalized Carbon Nanotube
GDL: Gas Diffusion Layer
GDE: Gas Diffusion Electrode
HER: Hydrogen Evolution Reaction
HEOR: Hydrogen Evolution and Oxidation Reactions
HFR: High frequency resistance
HOR: Hydrogen Oxidation Reaction
MEA: Membrane Electrode Assembly
MPL: Microporous Layer
OER: Oxygen Evolution Reaction
ORR: Oxygen Reduction Reaction
PEM: Polymer Electrolyte Membrane
PR; Polarization resistance
RDE: Rotating Disk Electrode

The disclosed invention provides a novel gas diffusion electrode that can be utilized in hydrogen evolution, hydrogen oxidation, oxidation reduction, and oxidation evolution reactions. Primarily, the gas diffusion electrode described in this specification is used in the PEM-based fuel cells and water electrolyzers. The disclosed gas diffusion electrode relies on the three dimensional dispersion of catalytic nanoparticles on or close to a highly conductive gas diffusion layer having optimized porosity (such electrode is referred to as “3D-net GDE”). It is believed that the three dimensional dispersion of the catalytic particles minimizes the contact resistance between the particles and maximizes the catalyst's accessibility to the potential reactants. In particular, the gas diffusion electrodes of prior art typically suffer from the saturation of the current density at a value less than 4 mA/cmZ for the hydrogen oxidation reaction due to hydrogen mass transport limit. This limit, however, is largely eliminated on the 3D-net GDEs and can be readily increased to as high as 100 mA/cm². With the mass transport limit largely removed in the 3D-net GDEs, it is possible to optimize activity of the 3D-net GDEs. While typically the catalytic activity of an electrode depends on the catalyst loading (i.e., catalyst density), the disclosed 3D-net GDEs do not require high catalyst loading and depend on the optimized and effective 3D-net structure, which can significantly increase the catalyst utilization.

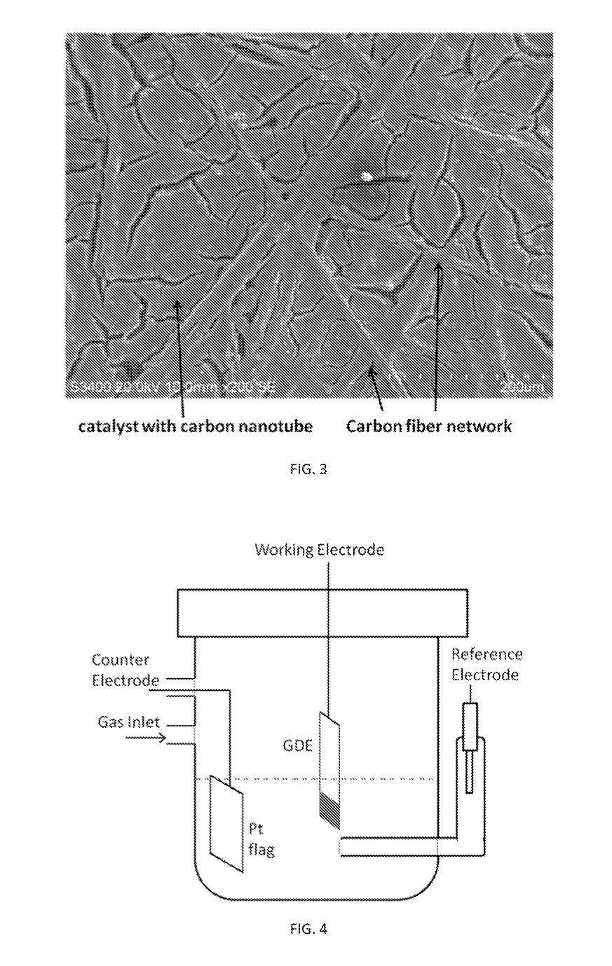

Generally, the gas diffusion electrode has a conducting porous network that functions as a gas diffusion layer coated/embedded with an ultra-thin (sub-micro) catalytic layer. FIG. 3 illustrates one such embodiment, where the catalyst layer is partly embedded into the carbon fiber network. The catalytic layer is preferably directly attached, or at least near the conducting network, while the porosity of the network maximizes the accessibility to the catalysts within the catalytic layer. That is, the nanocatalysts are directly bonded on a gas diffusion layer, so that the integrity of the catalyst layer holds preferably without the utilization of the polymer electrolyte membrane. Thus, facilitating the minimization of electronic, protonic, and diffusion resistances in the catalyst layer. This allows for a high dispersion of catalysts in 3D reaction volume that contributes to the enhancement of the reaction rate.

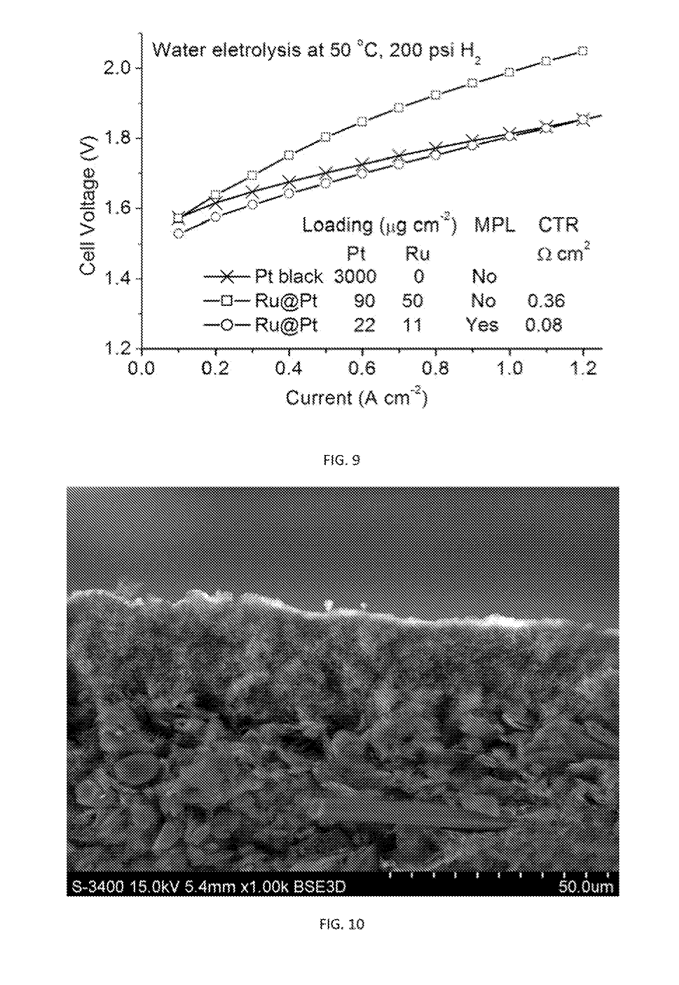

The conducting network is made a material that can conduct electric charge, yet sufficiently accessible to manipulation for the creation of a porous structure. Preferably, the conducting network is made from carbon or titanium and may optionally have a microporous layer (MPL) on one side to reduce surface roughness and allows fine tuning of the porosity and hydrophobicity of the gas diffusion electrode. FIG. 10 is an SEM image of such high performance GDE. Specifically, the illustrated GDE is fabricated using a carbon fiber based gas diffusion layer (GDL) covered with 10 to 20 μm of MPL (appears as foam). The catalyst layer (<2 μm) (white/bright offset) made from Ru@Pt nanocatalysts is coated/embedded on top of the MPL. In an embodiment where the 3D-net GDE is used in water electrolyzers, the microporous layer (MPL) is preferably used with hydrophobic GDL. In one embodiment, MPL is about 10 μm to 20 μm thick and made from fine carbon particles

Depending on the catalyst formulation(s), the catalytic nanoparticles can be attached on the gas diffusion layer to ensure its integrity and allow the gas diffusion electrode to function without a membrane. In one exemplary embodiment, the conducting network is made from carbon fibers and porous Ti sheets. The pores of the conducting network are preferably up to 200 μm in diameter and more preferably up to 50 μm in diameter. In some embodiments, the pores of the conducing network are between 10 and 50 μm.

The catalytic layer is about 0.5 to 4 μm thick and is made from a plurality of catalytic particles, preferably nanoparticles, having solid, hollow, or core/shell (shell part) structure made at least partially from metal, metal oxide, or metal alloy, where the metal is selected from platinum (Pt), palladium (Pd), gold (Au), rhodium (Rh), iridium (Ir), ruthenium (Ru), silver (Ag), or rhenium (Re). In one embodiment the nanoparticles are substantially spherical with an external diameter of less than 20 nm.

If the nanoparticle is a core/shell nanoparticle, the core can be selected from a suitable metal or metal alloy, such as, but not limited to, palladium (Pd), gold (Au), rhodium (Rh), iridium (Ir), ruthenium (Ru), osmium (Os), rhenium (Re), nickel (Ni), cobalt (Co), iron (Fe), copper (Cu), and combinations thereof², and the shell is selected from a suitable metal or metal alloy, such as, but not limited to, platinum (Pt), palladium (Pd), gold (Au), rhodium (Rh), iridium (Ir), ruthenium (Ru), silver (Ag), rhenium (Re), or alloys or combinations thereof. The core can be crystalline, semi crystalline or amorphous. ² It is to be understood, however, that the invention is not limited to only metal core and may include other materials which are well-known in the art including semiconductors.

The shell layer has thicknesses in the submonolayer-to-multilayer range. For purposes of this specification, a monolayer (ML) is formed when the surface of the core is fully covered by a single, closely packed layer comprising adatoms of a second material which forms a chemical or physical bond with atoms at the surface of the substrate. The surface is considered fully covered when substantially all available surface sites are occupied by an adatom of the second material. Preferably, the surface is considered fully covered when more than 90% of all available surface sites are occupied by an adatom of the second material, and more preferably when more than 95% of all available surface sites are occupied by an adatom of the second material. If the surface of the core is not completely covered by a single layer of the shell material, then the surface coverage is considered to be submonolayer. However, if the second or subsequent layers of the shell material are deposited onto the first layer, then multilayer surface coverage, e.g., bilayer, trilayer, etc., results. In one embodiment, a shell thickness is between 0.2 and 1 nm or, alternatively, less than 1 (sub-monolayer) to 3 atomic layers. In a more preferred embodiment, the external diameter of the nanoparticles is between 2 nm and 5 nm with a shell thickness of 2 atomic layers. The nanoparticles are preferably made of Pt shell and Ru core. Preferably, the total Pt metal loading is less than 50 μg cm⁻², which reduces the material cost by more than 98% compared to the amount of Pt used in commercial products (3000 μg cm⁻²)

In one embodiment, the disclosed gas diffusion electrode is prepared by a method that has the following essential steps: (i) uniformly dispersing a nanocatalyst in a solvent containing a binder to form a catalyst ink; (ii) uniformly painting a desired area of a gas diffusion layer (GDL) with the catalyst ink; (iii) allowing the ink to dry; and (iv) repeating catalyst painting to achieve desired catalyst loading.

The manufactured electrode can be used in fuel cells and electrolyzes. In one exemplary embodiment, the formation of a catalyst ink can be accomplished by dispersing a plurality of nanocatalysts in a solution of deionized water, isopropyl alcohol, ethanol, and a binder selected from a chemically stabilized perfluorsulfonic acid/PTFE copolymer, such as Nafion® in the acid form (DuPont™) or a high-viscosity agent, such as glycerol. The nanocatalysts are preferably made from a plurality of catalytic nanoparticles on fine carbon powder or fine carbon nanostructures, such as fullerenes (e.g., spherical fullerenes, nanotubes, nanohorns, and similar structures).

A novel (“hanging-strip”) testing method is disclosed for evaluating and optimizing catalytic behavior of gas diffusion electrodes on single electrode without mass-transport limitations, which are typically more than a hundred-fold lower than that used in MEA tests in the systems of the prior art. Therefore, the sensitivity of the RDE-based tests of prior art is quite low for the intrinsic catalytic activity, e.g. the hydrogen evolution reaction (HER) and/or the hydrogen oxidation reaction (HOR). Moreover, the potential window in RDE-based tests of prior art is only about 0.2 V, making it difficult to study its catalytic behavior at large overpotentials and high current densities of the oxidation reduction reaction (ORR). The disclosed “hanging-strip” method overcomes the limitations of prior art and provides a fast, cost-saving way (compared to MEA tests) to gain insights into the factors determining electrode performance.

In one embodiment, the method has the following essential steps: (i) coating a catalyst layer on one side and one end of a gas diffusion layer strip; (ii) holding such gas diffusion electrode vertically with the catalyst layer immersed in electrolyte solution and faced to a counter electrode; (iii) immersing a reference electrode in the electrochemical cell; and (iv) measuring electrocatalytic currents and impedance spectra at potentials against the reference electrode for single-electrode reactions. FIG. 4 is a schematic of an exemplary electrochemical cell used in the disclosed hanging strip method. Specifically, the electrochemical cell has a gas diffusion electrode (marked GDE) made from a gas diffusion layer strip coated and/or embedded with a catalyst layer made from a plurality of catalytic nanoparticles on one of its sides (shaded region). As shown, the GDE is vertically immersed in electrolyte solution and faced to a counter electrode (e.g., Pt flag). A Ag/AgCl(3M KCl) electrode is used as the reference electrode and the electrocatalytic currents and impedance spectra are measured at potentials against the reference electrode for single-electrode reactions.

The disclosed method affords a highly-enhanced gas-transport rate compared to commonly-used rotating disk electrode method. Preferably, the method is used in reactions where either the reactant or a product gas includes hydrogen or oxygen. In one embodiment, a catalyst layer is composed of Pt/C or Ru@Pt/C core-shell nanocatalysts painted over a prescribed area of the GDL. Preferably, the area of the GDL covered by the catalyst layer is between 0.2 and 2 cm² on one side of the GDL. Such 3D-net GDE is held vertically with the catalyst-coated end immersed in acidic (e.g., 1 M HClO₄ solution) such that the catalyst-coated side faces a Pt flag counter electrode. This arrangement utilizes the microporous channels inside the GDL to enhance the gas diffusion rate. It is believed that in such an arrangement, the hydrogen molecules get to the Pt catalyst on GDE much faster through microporous channels inside a GDL than by dissolving in the solution and then via forced convective diffusion to the Pt catalyst on a RDE.

In summary, 3D-net GDEs for the H ER, HOR, ORR, and OER can be fabricated to have excellent stability in the solution of the electrochemical cells. The tight bonding between catalysts and GDLs ensures the structural integrity of ultrathin catalyst layers. With the guidance provided by the disclosed hanging strip GDE method, considerable reduction of precious metal loading can be achieved for the HER, HOR, ORR, and OER by optimizing catalysts and GDE configurations.

### EXAMPLES

The examples set forth below also serve to provide further appreciation of the disclosed invention, but are not meant in any way to restrict the scope of the invention.

### Example 1

Ru@Pt core/shell nanoparticles at various Pt to Ru ratios (i.e., 0.1 to 1.3) were prepared on carbon support following a procedure described in a copending U.S. patent application Ser. No. 13/860,316, filed Apr. 10, 2013, which is incorporated by reference in its entirety. Catalyst inks were prepared by dispersing the carbon-supported metal catalysts in a solution of deionized water (18.2 MΩ, Millipore UV Plus), isopropyl alcohol (Mallinck-Baker), ethanol (200 proof, ACS/USP Grade, Pharmco Aaper) and 10 wt % Nafion® (perfluorinated resin, equivalent weight 1000, Aldrich). GDL strips, typically sized 1×4 or 1.4×3.7 cm, were weighed before painting the catalyst ink over an area of 0.2 cm² to 1 cm² at one end of the GDL strips. After the solvents had completely evaporated in air at room temperature, the increase in weight was used to calculate metal loading from the weight percentage of metals on the carbon support and the Nafion's dry weight. The best performing HER-HOR GDEs were made using carbon-based GDL with a MPL (e.g., Avcarb GDS1120, Fuel Cell Store). For the ORR, top performance was obtained using Toray carbon paper (TGP-H-090, Fuel Cell Store) with a MPL made of f-CNT and having f-CNT in catalyst inks. The functional groups of the f-CNTs can be SO₃H, CO₂H, or OH and the CNTs can be single wall or multi wall nanotubes. The Ti-based GDEs for the OER are prepared with an additional heat treatment at about 400° C. in air for 10 min.

### Example 2

The Ru@Pt/C catalysts from Example 1 or commercially available Pt/C catalysts (e.g., NanoComposix, Inc.; San Diego, Calif.) or Pt/C catalysts prepared by methods well known in the art (e.g., microwave-assisted polyol process described in Liu Z. et al. Journal of Power Sources Volume 139, Issues 1-2, 4 Jan. 2005, Pages 73-78; incorporated by reference in its entirety) were dispersed in a vial of deionized water (1 mg catalyst mL⁻¹) by placing it in an ultrasonication bath with ice for 5˜10 min (Branson 1510). An aliquot of the suspension (10 to 20 μL) was pipetted onto a polished glassy carbon rotating disk electrode (5 mm diameter, Pine Research Instrumentation). After drying in air at room temperature, the as-prepared thin-film rotating disk electrode was mounted onto a rotator as the working electrode in electrochemical measurements.

### Example 3

A Volta PGZ402 potentiostat (VoltaLab, Radiometer Analytical) was employed for measurements using conventional three-electrode electrochemical cells. Electrolyte solutions of 1 M concentration were prepared with 70% perchloric acid and lithium perchlorate (optima, Fisher Scientific). The GDE strip was held vertically with the catalyst-coated end immersed in the solution and positioned such that the catalyst-coated side faced a Pt flag counter electrode. We employed a reference electrode (Ag/AgCl, 3 M NaCl) with a double-junction chamber (Cypress Systems). All potentials are quoted with respect to the reversible hydrogen electrode (RHE).

Polarization curves for the HER-HOR were obtained in hydrogen-saturated electrolyte solutions by averaging the two nearly identical cathodic and anodic potential sweeps measured at 20 mV s⁻¹. They represent steady-state polarization curves, as verified by time-dependent measurements after a potential step. Typically, we determined the polarization resistance (PR) at 0 V by a linear fit within ±20 mA cm⁻². Electrochemical impedance spectroscopy (EIS) was obtained at a DC potential of 0 V with a peak-to-peak perturbation of 20 mV at an AC frequency ranging from 10 kHz to 0.1 Hz. The high frequency resistance (HFR) determined by the intercept on the Zᵣₑₐₗ axis was independent of potential, and was used for correcting the iR drop in the measured polarization curves and for calculating charge transfer resistance (CTR) via PR-HFR. To obtain the temperature dependence, we placed the electrochemical cell in water bath on a Super-Nuova hotplate (Thermo Scientific), and monitored the temperature with an Accumet AP110 pH/mV/Temp meter (Fisher Scientific) in another cell containing the same amount of electrolyte as did the cell for measurements.

Polarization curves for the ORR and OER were obtained in oxygen-saturated electrolyte solutions by averaging the cathodic and anodic potential sweeps at 10 mV s⁻¹. The HFRs are determined from EIS measured at 0.8 V for the ORR and 1.8 V for the OER. After measurements of HER-HOR on GDEs, the cell should be purged with inert gas before removing the GDE sample to avoid it being burnt due to having hydrogen inside the porous GDE mixed with oxygen in air.

### Example 4

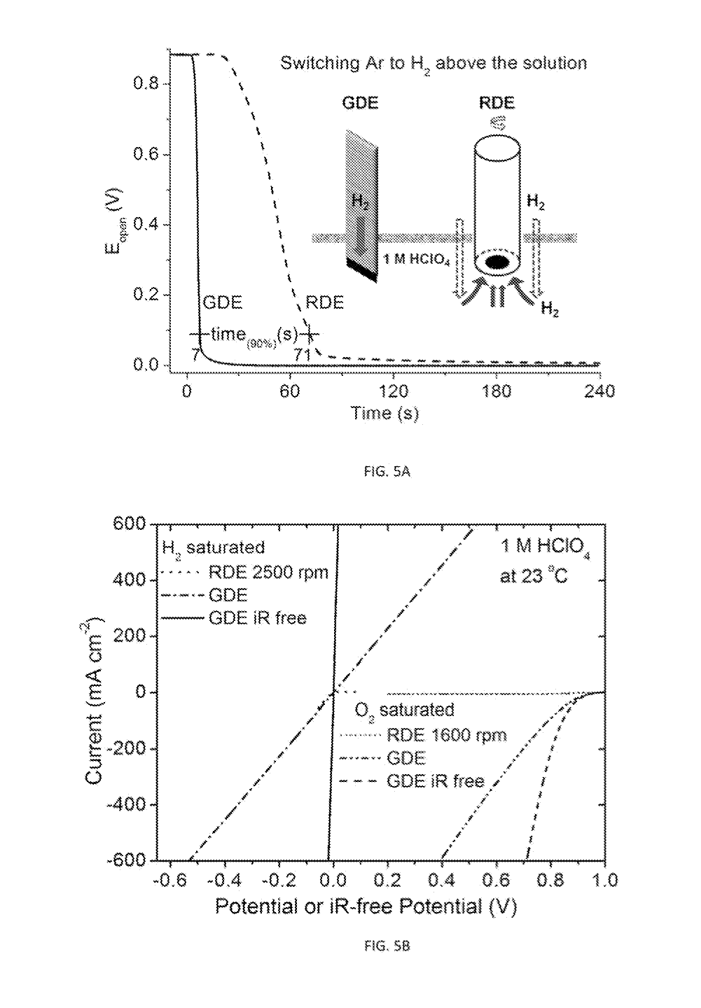

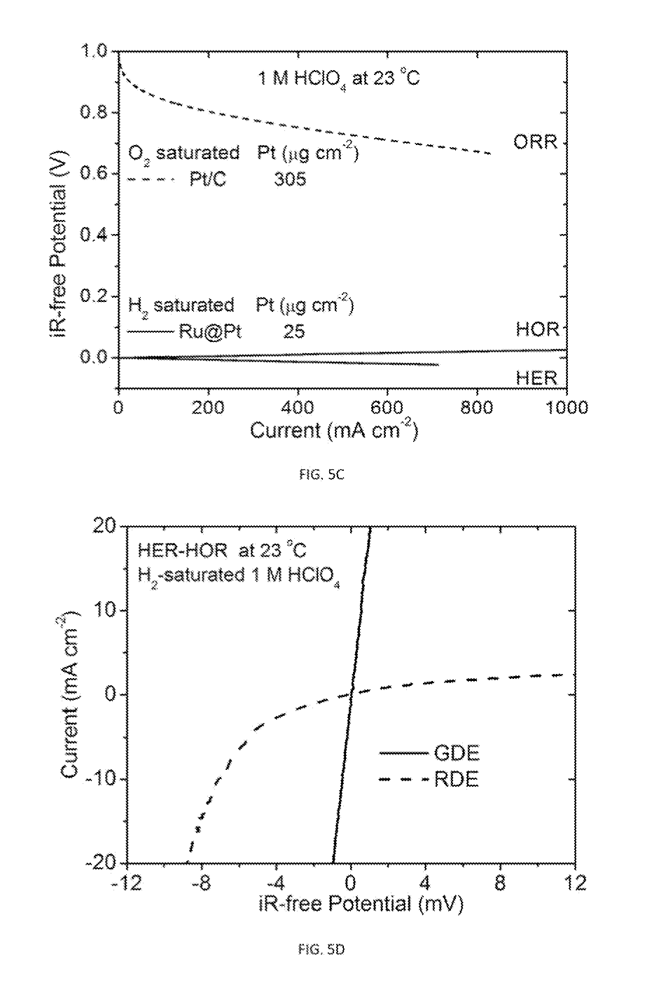

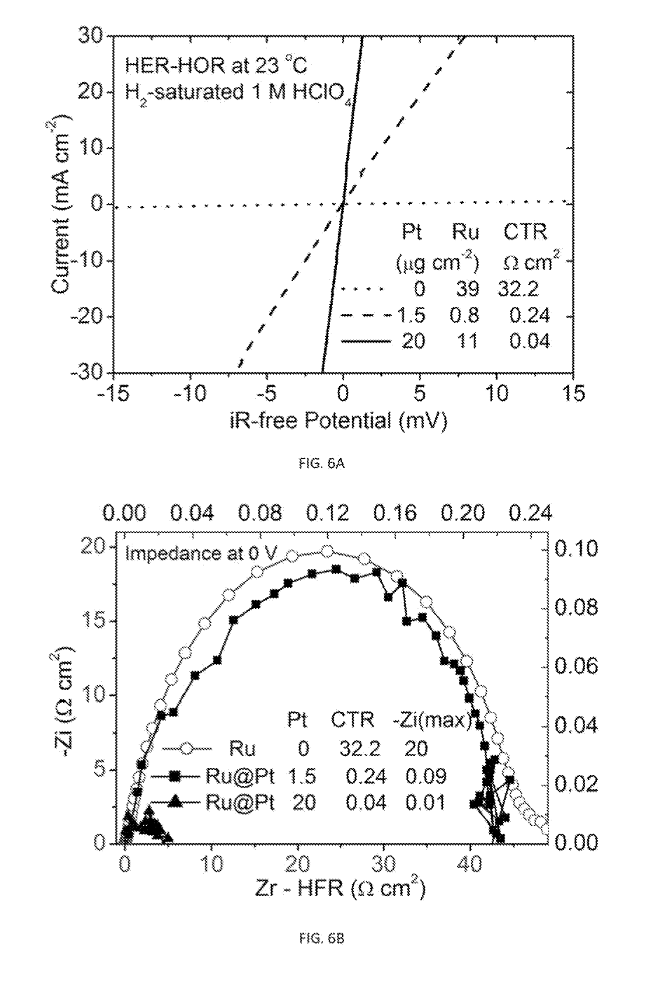

The 1×4 cm GDL strips were made into GDE samples for testing catalytic performance in an electrochemical cell under well-defined conditions. A catalyst layer composed of Pt/C or Ru@Pt/C core-shell nanocatalysts was painted over an area of 1×0.2 cm² at one end of a 1×4 cm GDL strip. Such a GDE sample is held vertically with the catalyst-coated end immersed in 1 M HClO₄ solution and positioned such that the catalyst-coated side faces a Pt flag counter electrode. This arrangement utilizes the microporous channels inside the GDL to enhance the gas diffusion rate. The effectiveness of this approach is illustrated by a simple experiment based on the change in open circuit potential on Pt electrodes with the concentration of hydrogen at its surface. As shown in FIG. 5A, the open circuit potential in Ar-purged 1 M HClO₄ solution is around 0.88 V, which decreased by 90% to 0.088 V in 7 seconds on a ODE, i.e. ten times quicker than on a RDE after the inlet gas above the solution is switched from Ar to H₂. The hydrogen molecules get to the Pt catalyst on GDE much faster through microporous channels inside a GDL than by dissolving in the solution and then via forced convective diffusion to the Pt catalyst on a RDE.

### Example 5

The RDE and GDE measurement methods were compared using the GDEs samples with the same 0.2 cm² electrode area as the RDE electrodes for the HER, HOR, and ORR. FIG. 5B shows that while the current for the HOR and ORR on the RDEs are limited by the reactants' mass transport at 3 and 6 mA cm⁻², respectively (dotted lines), these limitations are removed on the well-fabricated GDEs, where the currents measured were over 600 mA cm⁻², viz, more than a hundred times higher (dot-dash lines).

With measured current density up to sub-A cm⁻², the resistance-induced voltage loss, i.e., an iR drop becomes significant. The iR corrections are made using high-frequency resistances (HFRs) determined from impedance measurements. The iR-free polarization curves (solid and dash lines) shown in FIG. 5B are plotted in FIG. 5C as a function of current density (i.e., axes are switched and current density using absolute values), as is commonly plotted for the polarization measured in membrane electrode assemblies (MEAs). The ORR curve in FIG. 5C exhibits features comparable with the typical fuel cell polarization curves, indicating a wide potential window opened on GDEs for studying the kinetics of the ORR over a sufficiently high current range. The HER and HOR curves (solid lines) reveal the linear and symmetric polarization behavior on the GDE. This feature distinctly differs from that on the RDE.

FIG. 5D shows the iR-free HER-HOR polarization curves for the same amount of the catalysts on a RDE and a GDE over small overpotentials. In contrast to the high currents on the GDE, the curved RDE polarization denotes that an insufficient rate of gas diffusion on the RDE not only limits the HOR current at positive potentials when hydrogen is the reactant, but also lowers the HER current at negative potentials when hydrogen is the product. The effect especially is strong near 0 V. While over-saturation of hydrogen slows down the HER on the RDE, enhanced out-flow of hydrogen by the microporous gas-channels in the GDE reveals the linear and symmetric behavior for the HER-HOR on well-fabricated GDEs. Thus, the CTR at the reversible potential affords us a convenient describer for the HER-HOR activity. The CTR values can be determined from linearly fitting the iR-free polarization curve, or, equally, by fitting measured polarization curve to get polarization resistance (PR), and then subtracting the HFR from the PR.

### Example 6

The exceptionally high HER-HOR activity on Pt is illustrated in FIG. 6A and FIG. 6B by two representative polarization curves and impedance spectra for the Ru@Pt nanocatalysts in comparison to that for Ru nanocatalysts. The CTRs are determined by linear fitting over a range of ±20 mA cm⁻² current. While Ru nanoparticles are active for the HER-HOR, its CTR is more than two orders-of-magnitude higher than those on the Ru@Pt nanoparticles. In other words, the activity that is proportional to 1/CTR is far lower on Ru than on Pt containing catalysts. With only 1.5 and 20 μg cm⁻² Pt, we obtain, respectively, 0.24 and 0.04 Ωcm² CTR, on Ru@Pt/C in 1 N acid at 23° C. This magnitude differences in activity also is reflected in the maxima on −Zi axis observed in the Nyquist plot of impedance in FIG. 6B.

### Example 7

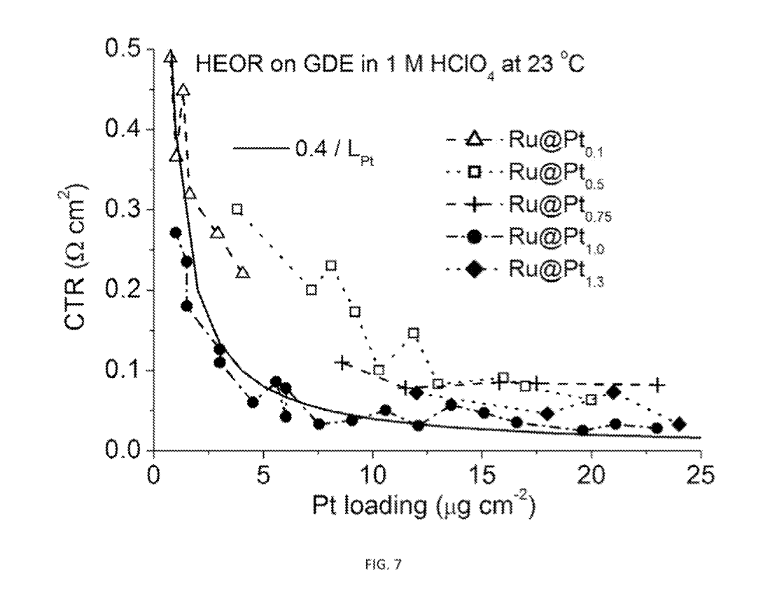

The loading dependent CTRs are measured for Ru@Pt nanocatalysts with different Pt-shell thicknesses to determine the optimal shell thickness and the minimal Pt loading required for top performance. FIG. 7 illustrates the results for five Ru@Pt catalysts that have Pt:Ru atomic ratios ranging from 0.1 to 1.3 with an average particle size from 3 to 4 nm. The Pt shell thicknesses are about 1 and 2 atomic layers for Ru@Pt_{0.5} and Ru@Pt_{1.0}, respectively (Hsieh et al. Nature Communications 4:2466, 2013; incorporated by reference in its entirety). With Pt loading from 1 to 25 μg cm⁻², the best performance was found with the bilayer Ru@Pt_{1.0} catalyst (circles in FIG. 7). The black line shows that the data follow a trend of 0.4 Ωcm² per μg cm⁻² Pt loading. Increasing Pt loading from 1 to 10 μg cm⁻² led to a drop of CTR from 0.4 to 0.04 Ωcm². With Pt loading in 20-30 μg c⁻² range, the CTR can be as low as 0.01 Ωcm², which is at the uncertain level of measured HFR.

### Example 8

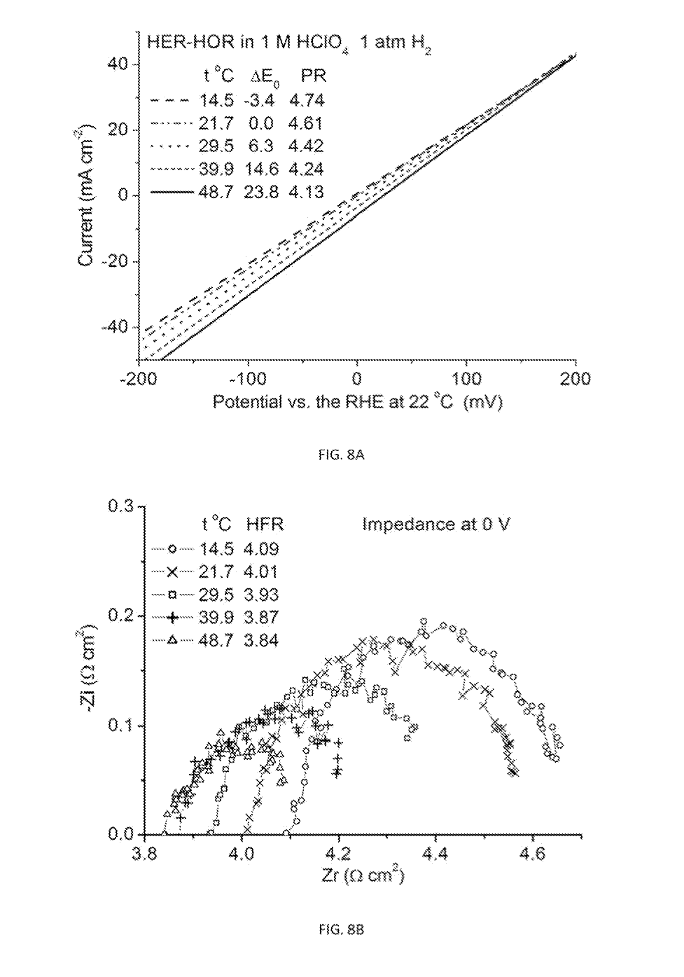

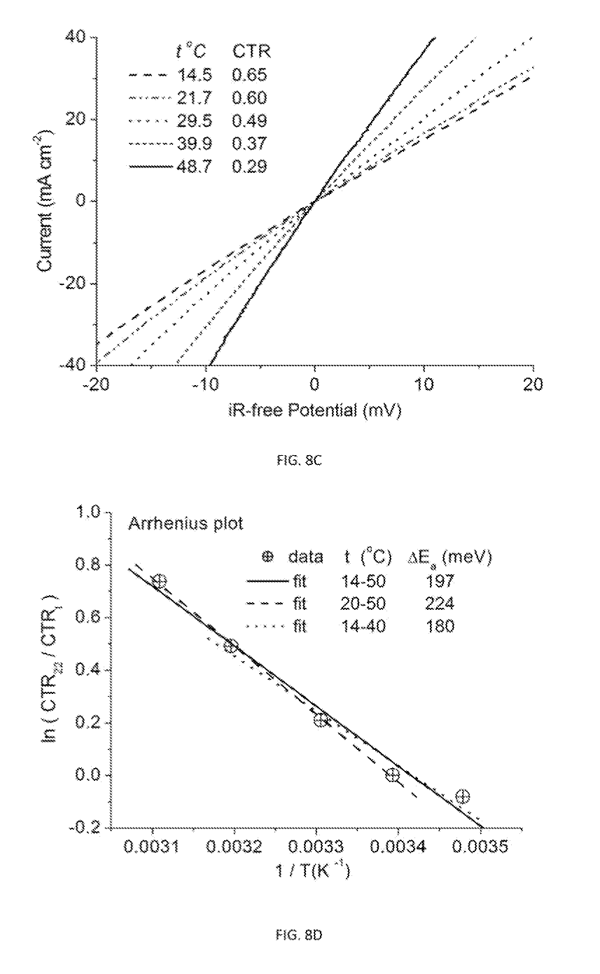

The temperature-dependent HER-HOR activities were measured using a GDE in an electrochemical cell. FIG. 8A and FIG. 8B show how the polarization curves and impedance vary with temperature. From the iR-free polarization curves (FIG. 8C), CTR as a function of temperature is obtained, which leads to the Arrhenius plot in FIG. 8D. From the linear fits, the apparent activation energy for the HER-HOR on Ru@Pt catalysts in acids is determined to be 0.2 eV or 19 kJ/mol. This value means the activity enhancement factor is 1.9 and 3.5, respectively, for 50 and 80° C. compared to 23° C. In other words, the CTR values are lower by these factors at elevated operating temperatures.

### Example 9

The relevance of the CTRs measured in Examples 7 and 8 were validated with actual performance in water electrolyzers by the MEA tests using two GDE samples composed of Ru@Pt catalysts as the cathodes for hydrogen evolution in comparison with the baseline of commercial PEM water electrolyzers. As shown in FIG. 9, one GDE sample (open squares) exhibited higher cell voltages, i.e., poorer performance, than did the baseline (crosses), while another sample (open circles) achieved the same performance as the baseline. The results are consistent with the CTRs measured in solution being significantly higher for the former (0.36 versus 0.08 Ωcm²).

Despite of lower catalyst loading, the sample made using a hydrophobic GDL that has a MPL in contact with the catalyst layer performed better, confirming the importance of optimizing the porosity and hydrophobicity near the catalyst layer. Unlike in fuel cells where the water is the product that needs to be removed, in water electrolyzers water is the reactant. Nevertheless, the results show for the first time that using hydrophobic GDL with MPL is favorable as it provides better gas channels for hydrogen out flow.

An MPL having carbon particles also reduces the surface roughness of the carbon fibers. In FIG. 10, the cross-section scanning electron microscopic image of the GDE shows a thin (˜2 μm) metal catalyst layer (bright) on a GDL with a 10-20 μm thick MPL.

### Example 10

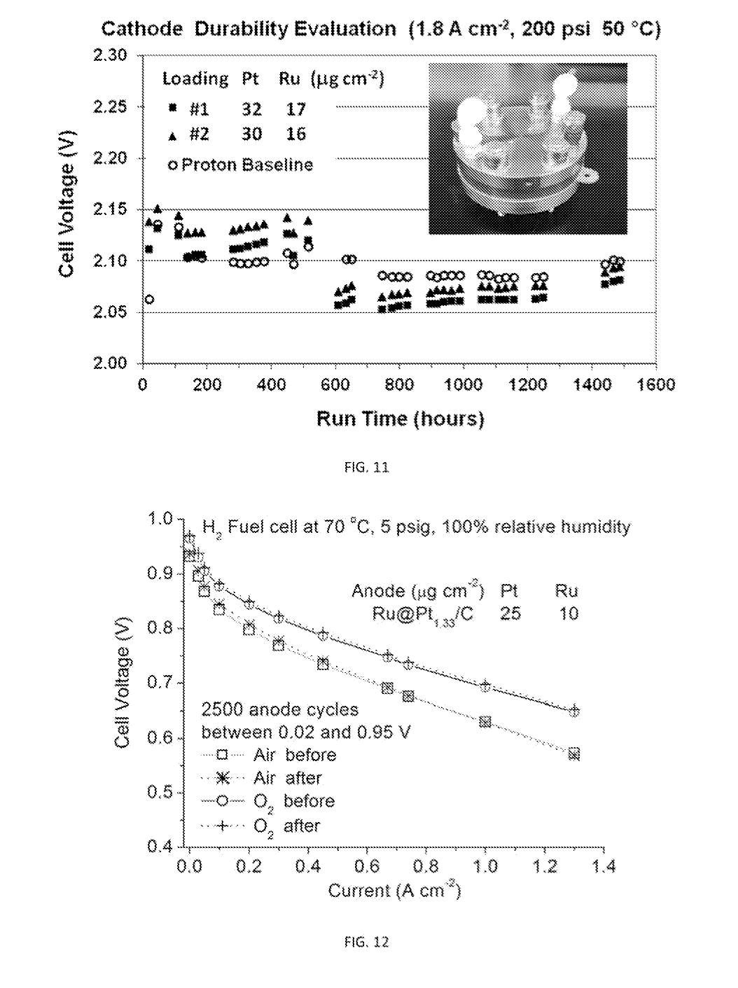

Two ultralow-Pt-content GDE samples were examined under water electrolysis operating conditions (50° C., 200 psi H₂). The samples exhibited excellent durability over 1500 hours. As shown in FIG. 11, their cell voltages at 1.8 A cm⁻² were comparable with the baseline.

The results confirmed that using the GDE approach for fabricating high performance, low cost cathode in water electrolyzers is feasible. With total metal loading <50 μg cm⁻², the material cost is reduced by >98% compared to the baseline made with 3000 μg cm⁻² Pt in commercial products.

### Example 11

GDEs composed of Ru@Pt nanocatalysts were examined on the anode in hydrogen PEM fuel cells. The GDEs' durability under fuel cell operation conditions was verified at higher operating temperature (70° C.) with 2500 anode potential cycles (0.02 to 0.95 V for ˜65 hours) by Ballard Power Systems, a fuel cell producer. This test used the protocols for accelerated stress test mimic fuel cell start-up/shut-down cycles that cause high potentials up to 0.95 Vat the anode. FIG. 12 shows unchanged polarization curves after the potential cycling on the GDE made of Ru@Pt with only 25 μg cm⁻² Pt loading.

Having a Ru core not only lows the cost of catalyst because Ru is usually more than ten times less expensive than Pt, but also enhances catalysts' tolerance to trace amount (10 ppm) of poisoning carbon monoxide (CO) in the reformates. Reformates, i.e., hydrogen produced by reforming natural gas or other carbon-containing fuels, are projected ˜40% cheaper than pure hydrogen generated by water electrolysis. However, commonly used Pt nanocatalysts are prone to CO adsorption resulting in more than 40% efficiency loss. Thus, the CO-caused performance loss on the anode for the HOR can be reduced to <10% so that reformates can be used to lower the operational cost of PEM fuel cells.

### Example 12

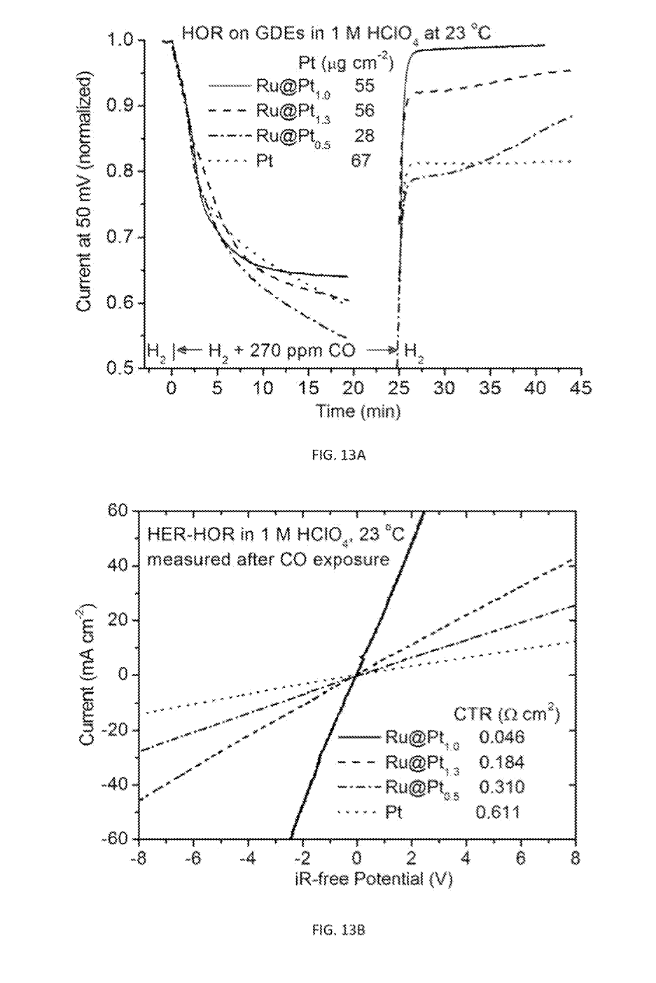

The optimal Pt shell thickness for operating with reformates was determined using hanging strip GDE test method. As shown in FIG. 13A, the GDE sample made of bilayer-thick Ru@Pt_{1.0} catalysts exhibited the least drop in the HOR current after CO-containing hydrogen was introduced among four GDE samples. The distinction is even clearer by comparison of the currents after switching back to pure hydrogen. The currents on all three Ru@Pt catalysts are ended higher than on the Pt catalyst demonstrating the benefit effect of Ru cores. More remarkably, the nearly complete (99%) recovery on the Ru@Pt_{1.0} catalyst clearly identified the optimal Pt:Ru atomic ratio that is the controlling parameter for the Pt shell thickness. FIG. 13B shows the polarization curves after the CO exposure. The CTR minimized at Pt:Ru atomic ratio 1.0 with the value lowered by a factor of 4 and 6.7, respectively, than on the catalysts with 1.3 and 0.5 Pt:Ru ratio.

### Example 13

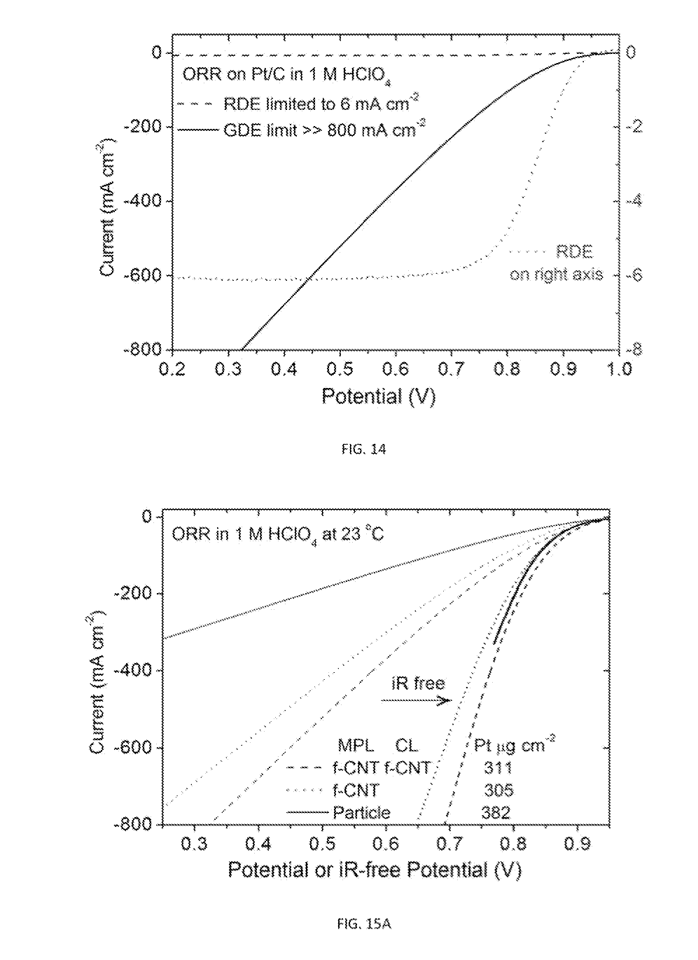

ORR polarization curves were measured for GDE and RDE samples composed of Pt/C nanocatalysts. As shown in FIG. 14, the ORR current is plotted as the negative current and overpotential for the ORR increases with decreasing potential versus the RHE. On the RDE, the ORR current levels off about −6 mA cm⁻² below 0.7 V. The current range on the GDE increases to −800 mA cm⁻² without a sign of leveling off, indicating the absence of mass transport limits in the current range more than 100 times larger than that on RDEs. The GDE solution test method opens a wide current and potential range for in-depth studies of catalytic behavior that is important for optimizing the GDE design and fabrication.

### Example 14

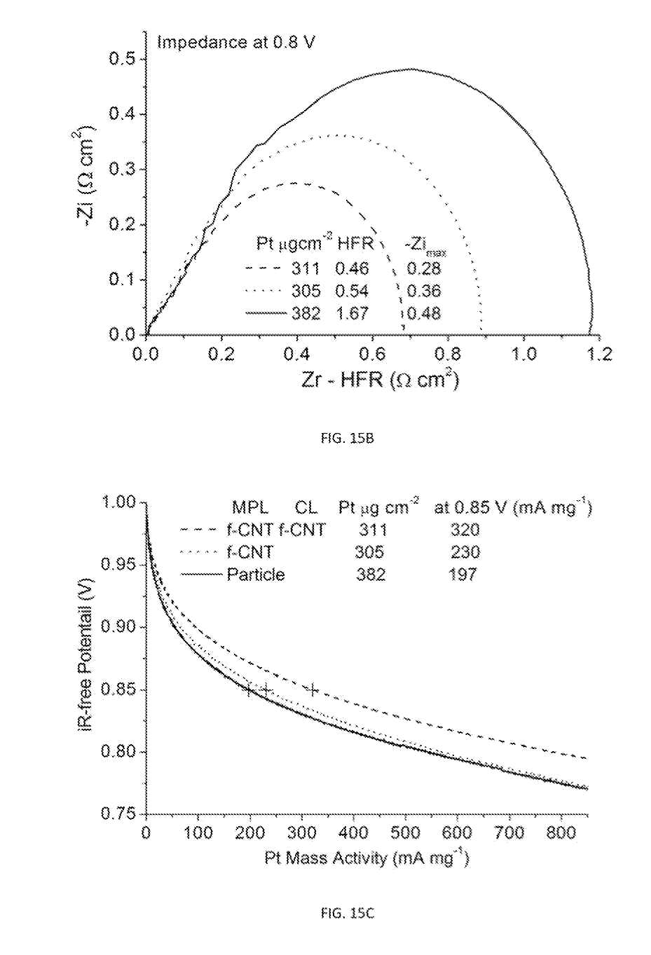

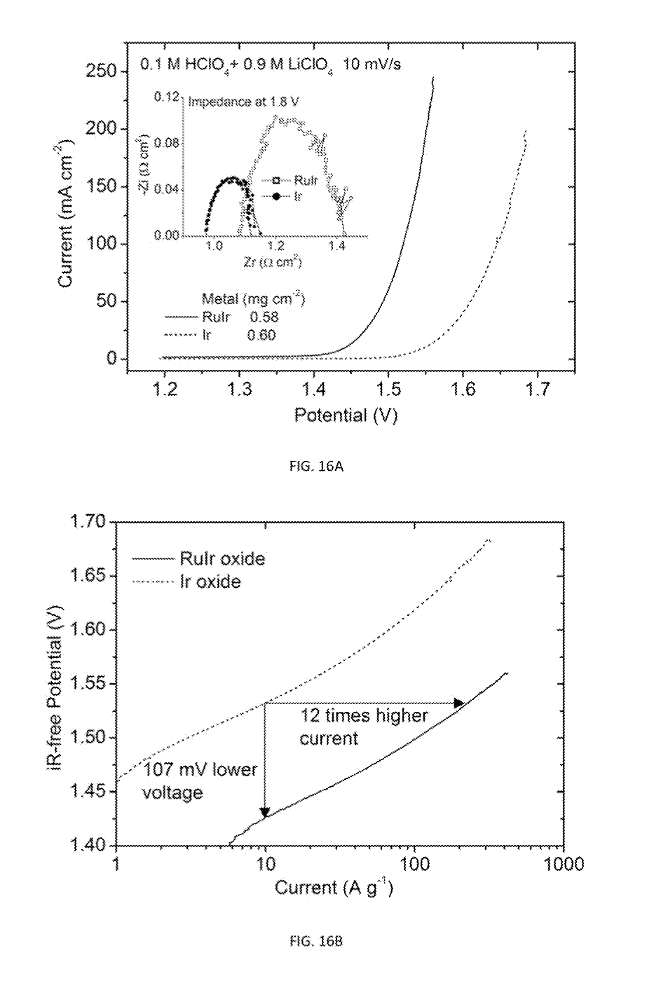

The functionalized carbon nanotubes (f-CNTs) were used to improve the cathode performance in fuel cells for the ORR. Two GDE samples were made with the MPL comprised of f-CNTs, one of them also has f-CNTs in the CL that allowed a reduction of expensive Nafion by half. FIG. 15A and FIG. 15B show the polarization and impedance measured in acid solution for the ORR in comparison with one sample made of commercial GDL that has a MPL composed of carbon particles. The largest currents and lowest −Zᵢ₍ₘₐₓ₎ occurred on the sample with f-CNT in both MPL and CL. FIG. 15C shows the Pt mass normalized polarization curves, in which the improved performance with f-CNT beneath and in the catalyst layer is demonstrated.

### Example 15

The OER GDEs were examined in water electrolyzers. More corrosion-resistant Ti-based GDL is currently used in water electrolyzers for the OER since the anode operates at potentials far above 1.4 V. wherein carbon corrodes. The OER nanocatalysts also contain metal oxide. Despite these distinct difference, standalone OER GDEs are made with commercial Ir and newly developed RuIr nanocatalysts.

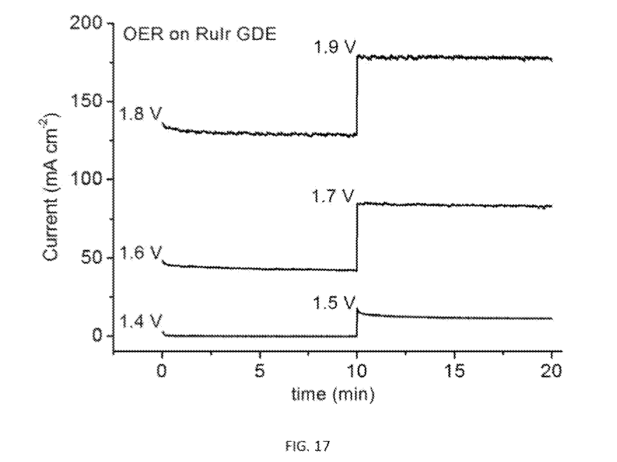

The OER activities of two types of the OER nanocatalysts are compared using the GDE stripe testing method. The measured polarization curves and impedance spectra in FIG. 16A show an lowering overpotential by ˜100 mV and a reduction of −Zi(max) by ˜50% on a newly developed RuIr catalysts in comparison with that on the commercial Ir catalyst. The plot in FIG. 16B with metal-mass-normalized currents indicates an order of magnitude increase in activity. The stability of measured currents on the RuIr oxide catalysts was shown FIG. 17, in which the currents are nearly constant after consecutive 0.1 V potential steps.

All publications and patents mentioned in this specification are incorporated by reference in their entireties. Various modifications and variations of the described materials and methods will be apparent to those skilled in the art without departing from the scope and spirit of the invention. Although the disclosure has been described in connection with specific preferred embodiments, it should be understood that the invention as claimed should not be unduly limited to such specific embodiments. Indeed, those skilled in the art will recognize, or be able to ascertain using the teaching herein and no more than routine experimentation, many equivalents to the specific embodiments of the invention described herein. Such equivalents are intended to be encompassed by the following claims.

1. A gas diffusion electrode, comprising:
a gas diffusion layer (GDL) having a three dimensional porous conductive network; and
a catalyst layer having a plurality of uniformly dispersed nanocatalysts directly bonded on the three dimensional porous network of the gas diffusion layer,
wherein the integrity of the catalyst layer is maintained without a polymer electrolyte membrane, facilitating minimization of electronic, protonic, and diffusion resistances of the catalyst layer.

2. The gas diffusion electrode of claim 1, further comprising a binder for bonding the catalyst layer to the gas diffusion layer.

3. The gas diffusion electrode of claim 2, wherein the binder is selected from a perfluorosulfonated ionomer or a high-viscosity agent.

4. The gas diffusion electrode of claim 1, wherein the gas diffusion layer comprises a porous conductive network with one side having a microporous layer.

5. The gas diffusion electrode of claim 1, wherein the porosity and hydrophobicity of the microporous layer are optimized based on the performed chemical reaction.

6. The gas diffusion electrode of claim 1, wherein the nanocatalyst comprises metal or metal oxide nanoparticles.

7. The gas diffusion electrode of claim 6, wherein the nanoparticles of the nanocatalyst are supported on carbon powder or nanotubes.

8. The gas diffusion electrode of claim 6, wherein the metal nanoparticle comprises a Ru(core)-Pt(shell) nanoparticle.

9. The gas diffusion electrode of claim 8, wherein the Pt shell comprises two atomic layers.

10. The gas diffusion electrode of claim 8, wherein a size of the metal nanoparticle and the thickness of the Pt shell are chosen to tolerate trace amounts of CO in a fuel source.

11. The gas diffusion electrode of claim 8, wherein a Pt loading in PEM water electrolyzers and fuel cells having negligible charge transfer resistance for hydrogen evolution and oxidation reactions is less than about 30 μg cm⁻².

12. A cathode for the hydrogen evolution reaction (HER) in polymer electrolyte membrane (PEM) water electrolyzers comprising the gas diffusion electrode of claim 1.

13. A cathode for the oxygen reduction reaction (ORR) in polymer electrolyte membrane (PEM) fuel cells comprising the gas diffusion electrode of claim 1.

14. The cathode of claim 13, wherein the nanocatalyst comprises metal or metal oxide nanoparticles supported on a microporous layer of carbon nanotubes.

15. The cathode of claim 14, wherein the carbon nanotubes comprise one or more hydrophilic groups selected from SO₃H, CO₂H, and OH.

16. The cathode of claim 15, wherein the carbon nanotubes with one or more hydrophilic groups enhance the performance of the oxygen reduction reaction (ORR) while lowering nanoparticles and a binder contents.

17. An anode for the oxygen evolution reaction (OER) in polymer electrolyte membrane (PEM) water electrolyzers comprising the gas diffusion electrode of claim 1, wherein the gas diffusion electrode comprises RuIr or Ir oxide catalysts attached to a Ti gas diffusion layer.

18. An anode for the hydrogen oxidation reaction (HOR) in hydrogen PEM fuel cells comprising the gas diffusion electrode of claim 1.

19. A method for optimizing a gas diffusion electrode (GDE), comprising:
placing the gas diffusion electrode of claim 1 in a solution of an electrochemical cell having a defined reference electrode and a counter electrode; and
observing an electrocatalytic reaction on the gas diffusion electrode under the desired conditions.

20. The method of claim 19, wherein:
the gas diffusion electrode comprises a gas diffusion layer (GDL) having a length of about 4 cm and a width of about 1 cm, the strip having first and second opposing sides and first and second opposing ends; and
wherein a catalyst layer is disposed on the first side at the first end up to about 1 cm from the first end of the strip.

21. The method of claim 20, wherein:
the gas diffusion electrode is held vertically with the first end immersed in a concentrated electrolyte solution and positioned such that the first side faces the counter electrode in the electrochemical cell.

22. The method of claim 20, wherein the counter electrode is a platinum flag counter electrode.

23. The method of claim 20, further comprising
conducting electrochemical measurements with reactant/product gas filling in the electrochemical cell above the electrolyte solution.

24. The method of claim 23, wherein the reactant/product gas comprises oxygen or hydrogen.

25. The method of claim 19, wherein the high frequency resistance (HFR) is determined by electrochemical impedance measurements.

26. The method of claim 19, wherein optimizing the gas diffusion electrode (GDE) based on the results derived from measured reaction currents after correcting the voltage drop due to HFR.

27. A method for fabricating a gas diffusion electrode (GDE) for use in gas reaction fuel cells and water electrolyzers, comprising the steps of:
uniformly dispersing a nanocatalyst in a solvent containing a binder to form a catalyst ink; and
uniformly painting a desired area on a gas diffusion layer with said catalyst ink to achieve desired catalyst loading.

28. The method of claim 27, wherein the catalyst layer is fabricated using an ink comprising water, isopropanol, ethanol, and Nafion.

29. A method of manufacturing an anode for the oxygen evolution reaction (OER) in polymer electrolyte membrane (PEM) water electrolyzers comprising
heat treating the gas diffusion electrode of claim 1 in air at about 400° C. for about 10 min,
wherein the gas diffusion electrode comprises RuIr or Ir oxide catalysts attached to a Ti gas diffusion layer.
